(19) United States
(12) Patent Application Publication
(10) Pub. No.: US 2009/0232226 A1
(43) Pub. Date: Sep. 17, 2009

(54) Local Digital Video Distribution System for Cable

(75) Inventors: Paul Gothard Knutson, Lawrenceville, NJ (US); Kumar Ramaswamy, Princeton, NJ (US)

Correspondence Address: Thomson Licensing LLC, P.O. Box 5312, Two Independence Way, PRINCETON, NJ, 08543-5312, US

(73) Assignee: THOMSON LICENSING, Boulogne-Billancourt (FR)

(21) Appl. No.: 12/227,257

(22) PCT Filed: May 31, 2006
(86) PCT No.: PCT/US2006/020730

§ 371 Date: Nov. 12, 2008

(51) Int. Cl. H04N 11/02; H04N 7/173

(52) U.S. Cl. 375/240.29; 725/127; 375/E07.135

(57) ABSTRACT

An apparatus for use in a cable system comprises a port for receiving a downstream cable transmission; a demodulator for receiving an upstream signal for providing a demodulated signal; and a modulator for modulating the demodulated signal for providing a downstream signal for addition to the received downstream cable transmission.

### BACKGROUND OF THE INVENTION

The present invention generally relates to communications systems and, more particularly, to cable television systems.

Current cable television (TV) systems offer a number of services to customers such as TV programming (both network and local), pay-per-view programming and Internet access. One example of a cable TV system is a hybrid fiber/coax based network that has a bandwidth capacity of 750 MHz (millions of hertz), or more, for delivering these services to their subscribers. This bandwidth capacity is typically divided between a down stream channel and an upstream channel. The downstream channel conveys not only the TV programming but also the downstream Internet data communications to each subscriber; while the upstream channel conveys the upstream Internet data communications from each subscriber.

### SUMMARY OF THE INVENTION

The above described distribution of cable TV bandwidth into a downstream channel and an upstream channel does not efficiently support local service offerings since any data communicated between endpoints must pass through the cable head-end. Therefore, and in accordance with the principles of the invention, an apparatus for use in a network comprises a port for receiving a downstream network transmission; a demodulator for receiving an upstream signal for providing a demodulated signal; and a modulator for modulating the demodulated signal for providing a downstream signal for addition to the received downstream network transmission.

In an illustrative embodiment in accordance with the principles of the invention, the apparatus is a video server coupled to a cable system for receiving an upstream transmission conveying video content and for retransmitting the received upstream transmission downstream to at least one cable endpoint of the cable system; wherein the server is located downstream from a head-end of the cable system.

In another illustrative embodiment in accordance with the principles of the invention, the apparatus is a video server coupled to a cable system for receiving an upstream transmission conveying video content and for retransmitting the received upstream transmission downstream to at least one cable endpoint of the cable system by using at least one video channel of the cable system.

### BRIEF DESCRIPTION OF THE DRAWINGS

FIG. 1 shows an illustrative cable system in accordance with the principles of the invention;

FIG. 2 shows an illustrative frequency spectrum in accordance with the principles of the invention;

FIG. 3 shows an illustrative embodiment of a server in accordance with the principles of the invention;

FIG. 4 shows another illustrative cable system in accordance with the principles of the invention;

FIGS. 5-9 show other illustrative embodiments of a server in accordance with the principles of the invention;

FIG. 10 shows another illustrative cable system in accordance with the principles of the invention;

FIG. 11 shows another illustrative embodiment of a server in accordance with the principles of the invention;

FIGS. 12-14 illustrate bandwidth management in accordance with the principles of the invention;

FIGS. 15-18 show illustrative embodiments of a programmable bandwidth device in accordance with the principles of the invention; and

FIGS. 19 and 20 show illustrative embodiments of endpoints in accordance with the principles of the invention.

### DETAILED DESCRIPTION

Other than the inventive concept, the elements shown in the figures are well known and will not be described in detail. Also, familiarity with television broadcasting and receivers in the context of terrestrial, satellite and cable is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) ATSC (Advanced Television Systems Committee) (ATSC) and ITU-T J.83 “Digital multi-programme systems for television, sound and data services for cable distribution” is assumed. Likewise, other than the inventive concept, familiarity with satellite transponders, cable head-ends, set-top boxes, downlink signals and transmission concepts such as eight-level vestigial sideband (8-VSB), Quadrature Amplitude Modulation (QAM), out-of-band control channels and receiver components such as a radio-frequency (RF) front-end, or receiver section, such as a low noise block, tuners, and demodulators is assumed. Similarly, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements. Also, as used herein, the term “endpoint” includes, but is not limited to, stations, personal computers, servers, set-top boxes, cable modems, etc.

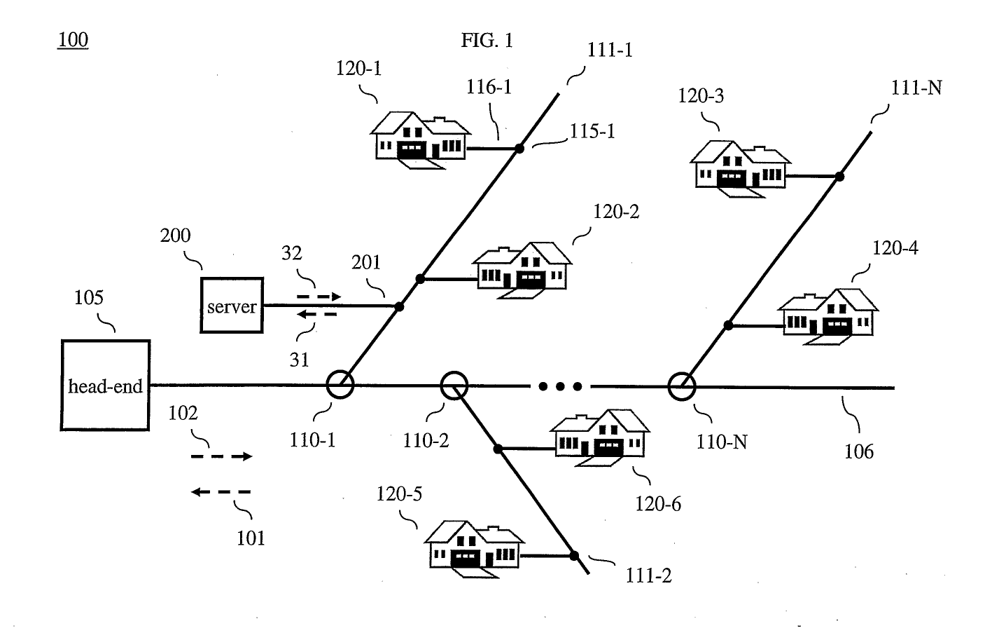

Turning now to FIG. 1, an illustrative cable system 100 in accordance with the principles of the invention is shown. Illustratively, cable system 100 is a hybrid-fiber coax (HFC) system. For simplicity, the fiber portion is not described herein. It should be noted that although the inventive concept is described in the context of coaxial cable (coax), the inventive concept is not so limited and can be extended to the processing of fiber optic signals. A plurality of stations, as represented by stations 120-1 to 120-6, are connected to a common head-end 105 by a tree and branch cable network. In the context of the inventive concept, a head-end is an example of a controller for a network. Each station is associated with a cable subscriber. Each station includes, e.g., a set top box for receiving video programming and a cable modem for bi-directional data communications to a two-way network, e.g., the Internet. Head-end 105 is a stored-program-processor based system and includes at least one processor (e.g., a microprocessor) with associated memory, along with a transmitter and receiver coupled to the cable network (for simplicity, theses elements are not shown). Ignoring for the moment element 200, the cable network comprises a main coaxial cable 106 having a plurality of taps 110-1, 110-2 to 110-N. Each of these taps serves a corresponding feeder cable. For example, tap 110-1 serves feeder cable 111-1. Each feeder cable in turn serves one, or more, stations via a tap and a drop. For example, feeder cable 111-1 serves station 120-1 via tap 115-1 and drop 116-1. For the purposes of this description, it is assumed that the devices of cable network 100, e.g., taps, drops, etc., are addressable and controllable by head-end 105 via an out-of-band signaling channel (not shown in FIG. 1). Other than the inventive concept, the use of an out-of-band signaling channel to address and control devices in particular portions of the cable network is known. For example, an out-of-band control channel that is a frequency shift keying (FSK) based can be used for both addressing and control of devices in a cable network. One such system is the Addressable Multi-Tap Control System available from Blonder Tongue Laboratories, Inc.

In cable system 100, communications between head-end 105 and the various stations occurs in both an upstream direction and a downstream direction. The upstream direction is towards head-end 105 as represented by the direction of arrow 101 and the downstream direction is towards the stations as represented by the direction of arrow 102. In accordance with the principles of the invention, cable system 100 includes a device that provides a local service offering to at least one portion of the cable network without having to pass through the head-end 105. As described herein, the local service offering provides video content. This is further illustrated in FIG. 1 by server 200, which is illustratively located at the beginning of feeder cable 111-1. However, the inventive concept is not so limited and a device including the server function can be located in any portion of the cable network. Similarly, the inventive concept is not limited to video and other services can be provided, e.g., audio content (streaming) can be provided to one, or more, endpoints of the cable system.

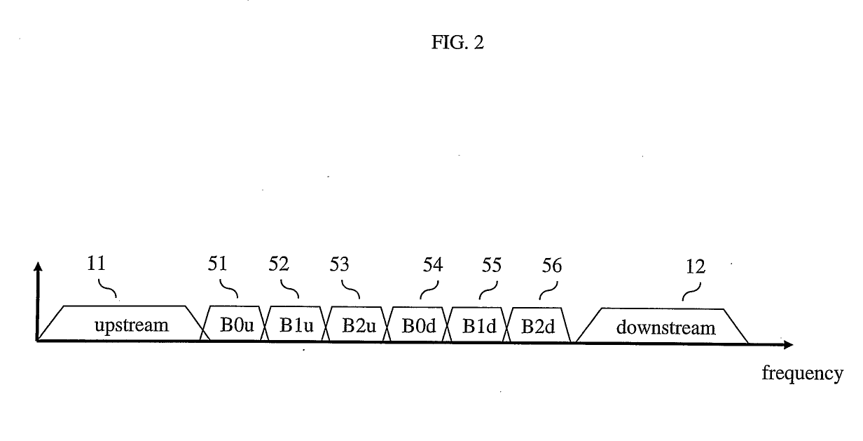

Turning for the moment to FIG. 2, and in accordance with one embodiment of the inventive concept, a number of communication bands are added to the existing cable frequency spectrum. Typically, a cable system provides services via an upstream band 11 and a downstream band 12. These services include Internet communications and television programming. However, in order to enable peer-to-peer communications, additional pairs of upstream and downstream bands are now added. These pairs of peer-to-peer frequency bands are different from those used by the cable system for Internet communications. Illustratively, FIG. 2 illustrates three pairs of peer-to-peer bands located between upstream band 11 and downstream band 12. However, the inventive concept is not so limited and more, or less, bands may be used and their placement in the spectrum may vary. It should also be noted that FIG. 2 is not to scale and that transition regions between bands may be required. As shown in FIG. 2, the three pairs of peer-to-peer bands are: B0, B1 and B2. The pair B0 comprises an upstream band, B0u (51) and a downstream band, B0d (54); the pair B1 comprises an upstream band, B1u (52) and a downstream band, B1d (55); and the pair B2 comprises an upstream band, B2u (53) and a downstream band, B2d (56).

Returning to FIG. 1, server 200 receives a communication from an endpoint located off of feeder cable 111-1 (e.g., station 120-1) via an upstream peer-to-peer band as represented by dashed arrow 31 (e.g., B0u of FIG. 2). Server 200 translates the frequency of this received signal and changes its direction to transmit that communication downstream to other users located off of feeder cable 111-1 via a downstream peer-to-peer band as represented by dashed arrow 32 (e.g., B0d of FIG. 2).

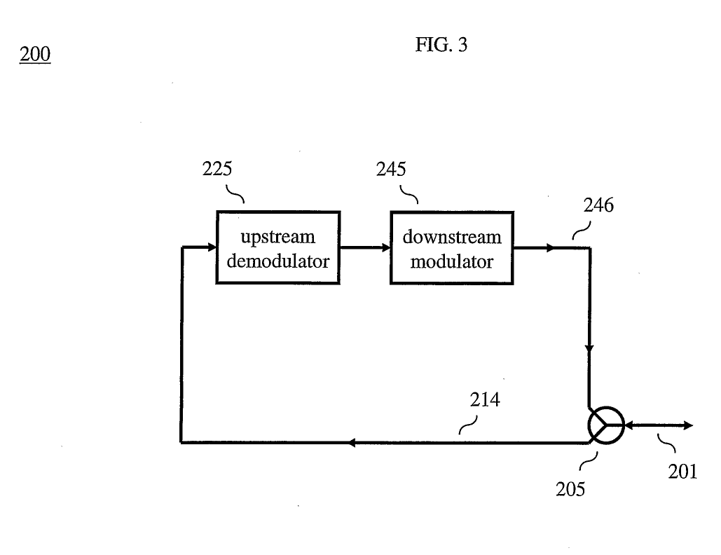

Turning now to FIG. 3, an illustrative embodiment of server 200 is shown. Server 200 comprises directional coupler 205, upstream demodulator 225 and downstream demodulator 245. Server 200 is coupled to a cable network via path 201. An upstream signal from drop 201 is received via directional coupler 205, which is provided to upstream demodulator 225 via signal path 214. Demodulator 225 is tuned to the appropriate peer-to-peer band. This can be accomplished via the earlier mentioned out-of-band control channel (not shown in FIG. 3) or can be preconfigured in server 200. Upstream demodulator 225 demodulates the received upstream signal in the designated peer-to-peer band (e.g., B0u) and provides a demodulated signal to downstream modulator 245. The demodulated signal represents video which can be in a compressed format (e.g., MPEG2, H.263, H.264, VC1, or other formats). Downstream modulator 245 modulates the demodulated signal to provide downstream signal 246 in the corresponding peer-to-peer band (e.g., B0d). Downstream signal 246 is coupled back to drop 201, via directional coupler 205, for transmission back downstream for receipt by, e.g., station 120-2. It should be noted that, if necessary, separate decoder and coder functions may be included in the demodulator and modulator, respectively. Alternatively, a separate decoder and coder may be added to the embodiment shown in FIG. 3 for further processing of the demodulated signal. For example, server 200 may provide a transcoding function, where the upstream video is coded in one video format; while the resulting downstream video is coded in another video format.

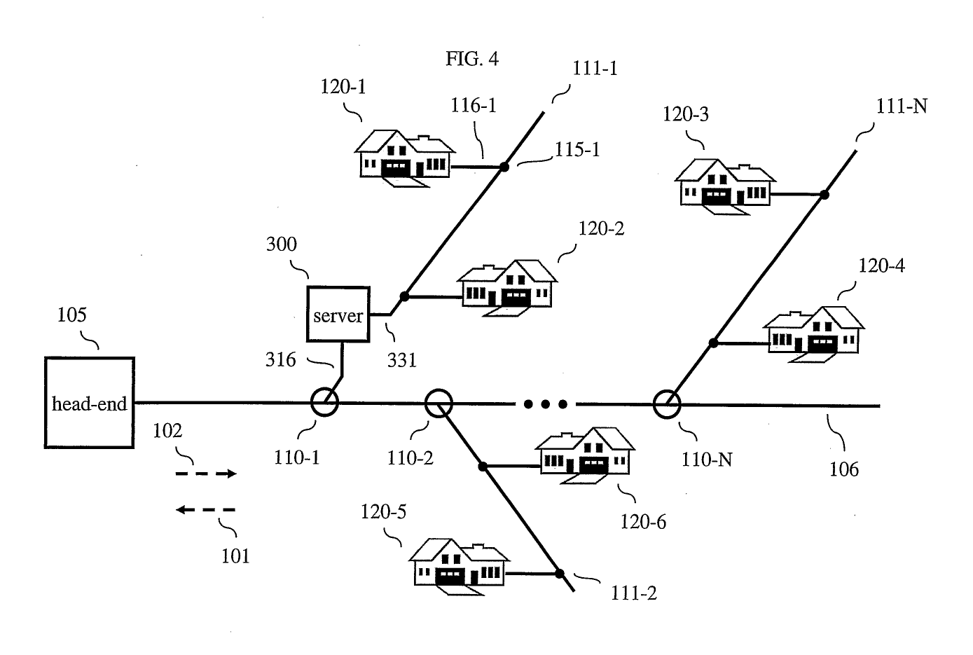

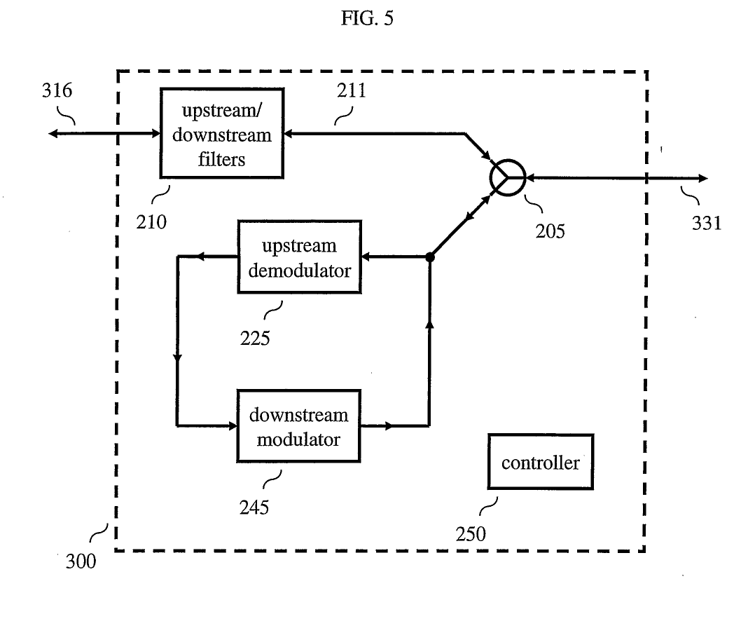

As noted above, a cable system may have one, or more, devices supporting a server function located in one, or more, portions of the cable network. Illustratively, FIG. 1 shows a server coupled to a feeder cable. Another illustrative location and type of server is shown in FIG. 4. The elements in FIG. 4 are similar to those found in FIG. 1 except for server 300, which serves feeder cable 111-1. As can be observed, all upstream and downstream communications pass through server 300. An illustrative embodiment of server 300 is shown in FIG. 5.

Server 300 comprises upstream/downstream filters 210, upstream demodulator 225, downstream modulator 245, controller 250 and directional coupler 205. Controller 250 controls the various elements of server 300 and is, e.g., a microprocessor with associated memory. For simplicity, the various control signals from controller 250 to different ones of the elements of server 300 are not shown. The operation of server 300 is similar to the description above with respect to server 200 except for the inclusion of upstream/downstream filters 210. In this example, it is assumed that a particular one of the peer-to-peer bands shown in FIG. 2 is designated for use by server 300. Upstream/downstream filters 210 have a stop band that corresponds to the designated peer-to-peer band (e.g., B0 of FIG. 2). As a result, all downstream signals received, via path 316, are first filtered by upstream/downstream filter 210 to provide a filtered signal, which is passed, via path 211 and directional coupler 205, to path 331 for further transmission downstream. Likewise, all upstream signals received, via path 331, are also filtered by upstream/downstream filter 210 before being passed, via path 316, for transmission further upstream. For example, if server 300 is configured to only use peer-to-peer band B0 of FIG. 2, upstream/downstream filters 210 have stop bands corresponding to peer-to-peer band B0u and B0d to prevent any interference with the peer-to-peer transmission using band B0 on feeder cable 111-1.

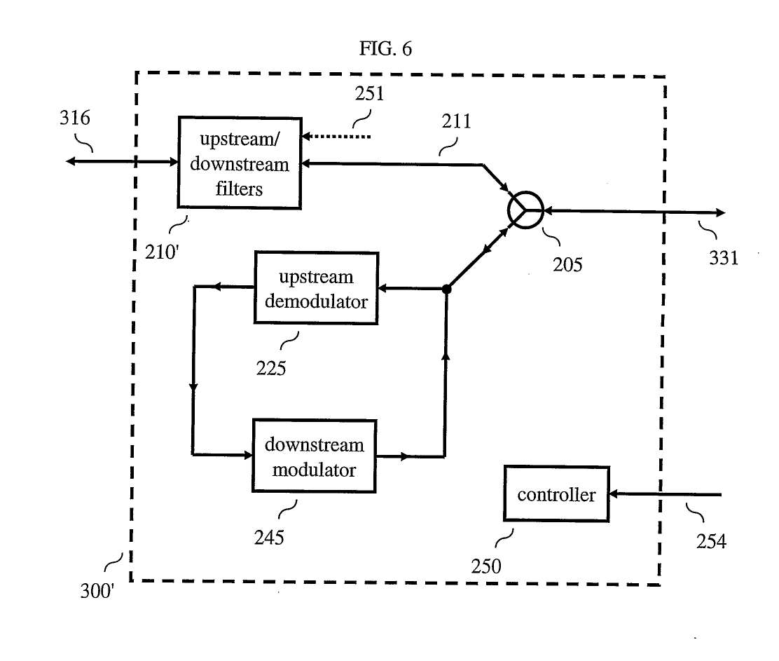

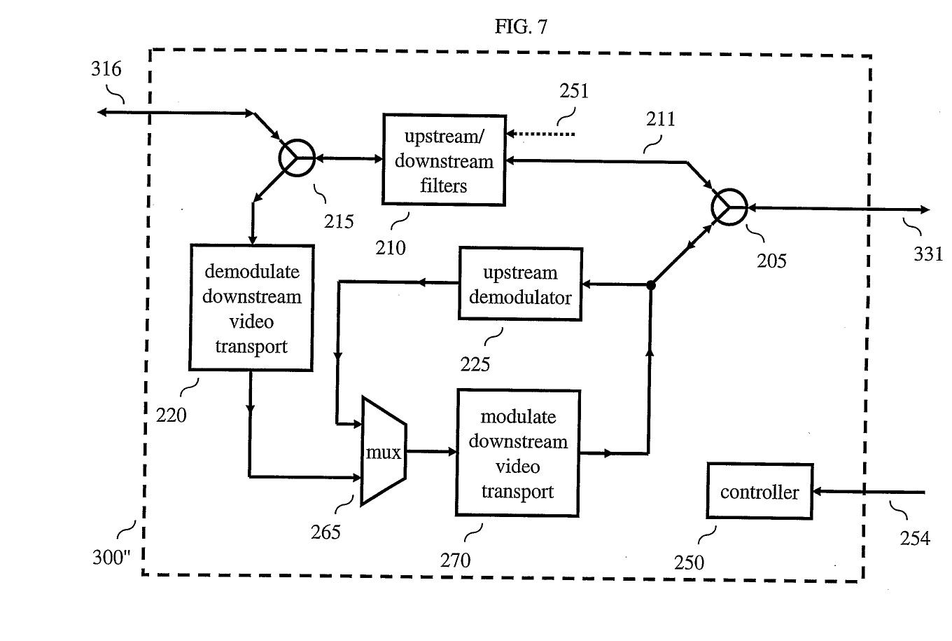

Another illustrative embodiment of a server 300 in accordance with the principles of the invention is shown in FIG. 6. This device is labeled as 300′. Server 300′ is similar to server 300 except that upstream/downstream filters 210 has been replaced with a programmable upstream/downstream filters 210′ and controller 250 allows a system control processor (not shown) in the cable network (e.g., located in head-end 105) the ability to configure server 300′ by setting filter parameters of upstream/downstream filters 210′. In particular, controller 250 is responsive to the above-mentioned out-of-band signaling channel (represented by signal 254) for setting the filter stop bands via control signal 251 (shown in dotted line form). In this regard, the out-of-band signaling channel is modified to include predefined commands that are associated with the different filter settings. Another illustrative embodiment of a server 300 in accordance with the principles of the invention is shown in FIG. 7. This device is labeled as 300″. Server 300″ is similar to server 300′ except for the addition of elements 220, 265 and 270. This illustrative embodiment provides a server for inserting the local video into an existing channel of the downstream video transport stream as opposed to using the above-described peer-to-peer bands. Illustratively, this use of an existing channel can be determined beforehand, e.g., channel 81 is designated for local video. As such, directional coupler 215 provides the downstream signal to element 220, which demodulates the downstream video transport portion thereof to provide a digital transport signal to multiplexer (mux) 265. As known in the art, the digital transport signal represents a number of video channels. Mux 265 replaces the video content on the designated channel with the video content conveyed by the demodulated signal from upstream demodulator 225 to provide a new video transport signal to element 270. Element 270 modulates this signal to provide a new downstream video transport signal for reception by one, or more, of the downstream stations on this portion of the cable network. Thus, these downstream stations merely have to tune their TVs or set top boxes to the designated video channel for viewing the local video thereon. In this embodiment, upstream/downstream filters 210 pass other downstream channels (e.g., those bands designated for providing Internet service) further along downstream via directional coupler 205.

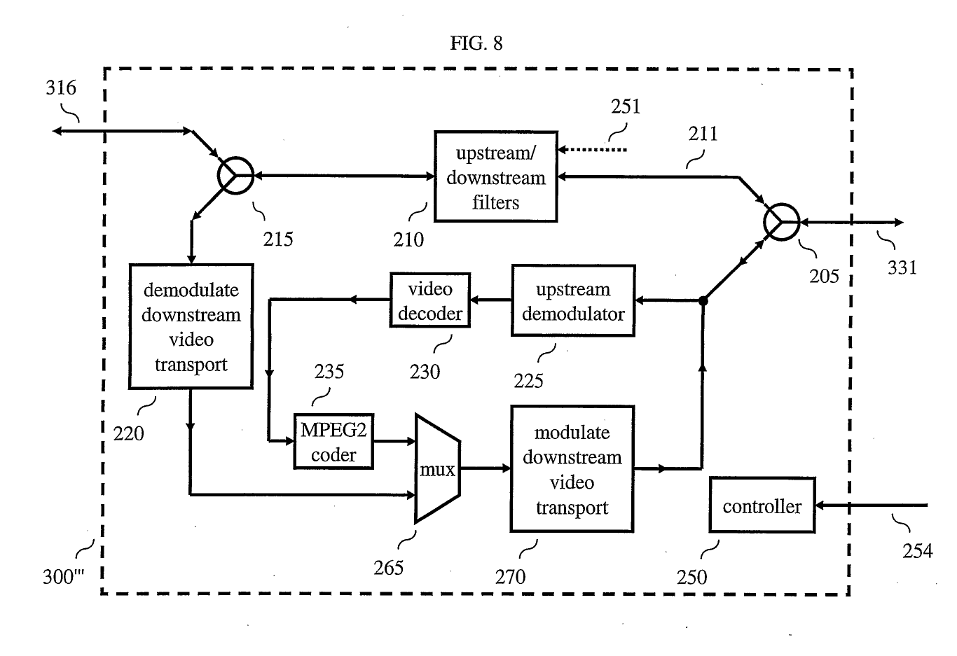

Another illustrative embodiment of a server 300 in accordance with the principles of the invention is shown in FIG. 8. This device is labeled as 300′″. Server 300′″ is similar to server 300″ except for the addition of elements 230 and 235. These elements provide a transcoding function. In other words, local video content may be received in any one of a number of compressed formats (other than MPEG2). Video decoder 230 suitably decompresses the demodulated signal provided by upstream demodulator 225 and provides the uncoded signal to MPEG2 coder 235, which encodes the video into an MPEG2 format for retransmission back downstream. It should be noted that although shown as separate elements, the decoding and coding functions may be a part of the demodulator and modulator, respectively.

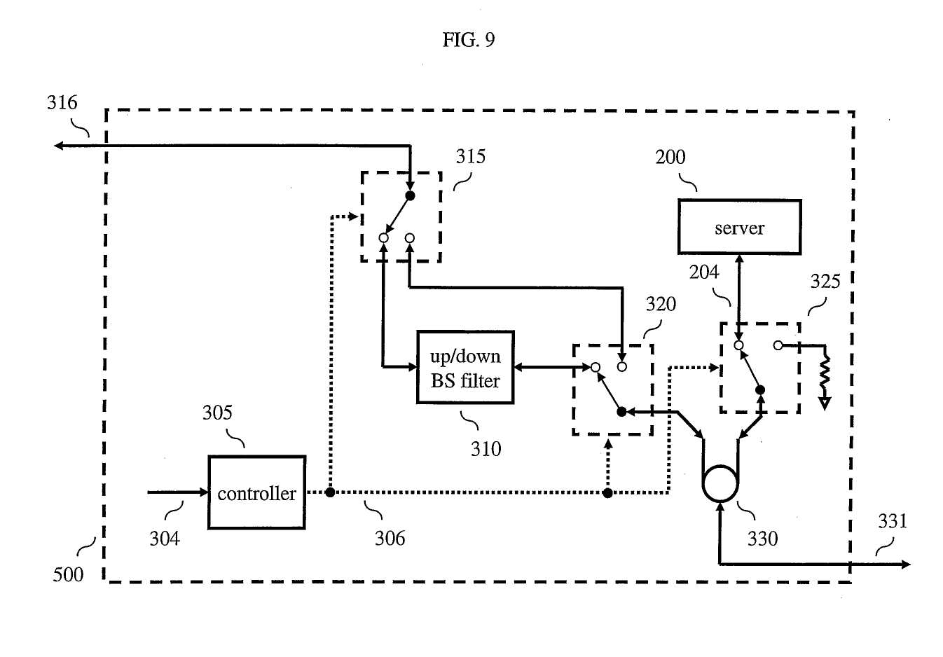

Another illustrative embodiment of a server in accordance with the principles of the invention is shown in FIG. 9. This device is labeled as 500 in FIG. 9. Server 500 comprises switches 315, 320 and 325, up/down band stop (BS) filter 310, controller 305, splitter 330 and server 200. The latter is identical to server 200 of FIG. 3, except that directional coupler 205 of FIG. 3 is coupled to path 204 as shown in FIG. 9. Controller 305 allows a system control processor (not shown) in the cable network (e.g., located in head-end 105) the ability to configure the server, e.g., whether it is on or off, establish frequency (e.g., which peer-to-peer bands to use) and/or gain settings. Illustratively, in this embodiment, controller 305 controls whether or not the server function is enabled for feeder cable 111-1. In particular, controller 305 is responsive to the above-mentioned out-of-band signaling channel (represented by signal 304) for enabling or disabling the server function in server 500 via switches 315, 320 and 325, which are controlled by controller 305 via control signal 306 (shown in dotted-line form). In this regard, the out-of-band signaling channel is modified to include predefined commands that are associated with enabling or disabling the server function in a particular device. When the server function is disabled, switches 315 and 310 are configured such that all upstream signals received, via path 331, from feeder cable 111-1 are passed, via splitter 330, to main coaxial cable 106. Likewise, all downstream signals received, via path 316, from the main coaxial cable 106 are passed, via splitter 330, to feeder cable 111-1. In addition, switch 315 disconnects server 200 from the network. However, when the server function is enabled, all upstream signals received, via path 331, from feeder cable 111-1 are also provided to server 200, via switch 325. Server 200 functions as described above to provide a local video signal back downstream. Further, when the server is enabled, up/down BS filter 310 is now switched in to further filter both upstream and downstream communications. BS filter 310 has stop bands that correspond to the peer-to-peer bands used by server 200. For example, if server 200 is configured to only use peer-to-peer band B0 of FIG. 2, up/down BS filter 310 has a stop band corresponding to peer-to-peer band B0 to prevent any interference with the peer-to-peer transmission using band B0 on feeder cable 111-1.

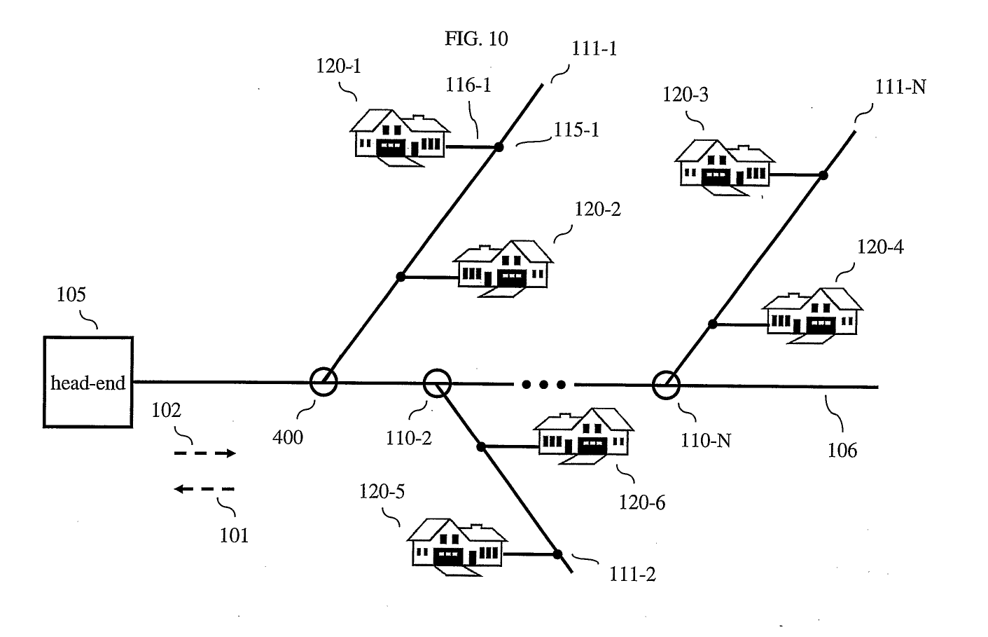

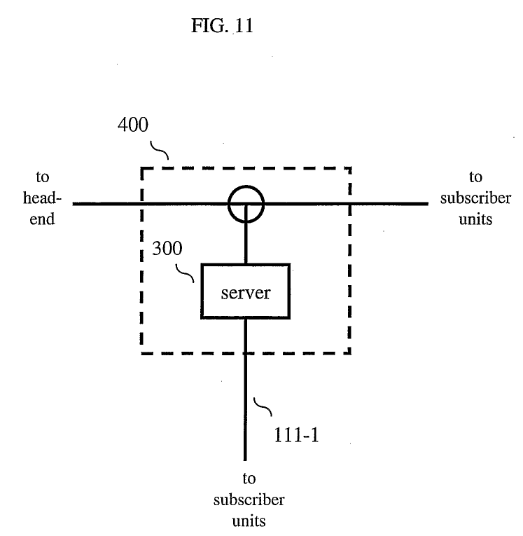

Another illustrative embodiment of a cable system in accordance with the principles of the invention is shown in FIG. 10. This figure is similar to FIG. 4 except for tap 400, which includes the server function. Tap 400 is shown in more detail in FIG. 11. As can be observed from FIG. 11, tap 400 comprises server 300 (described above) of FIG. 3 (or the servers of FIGS. 6, 7, 8 and 9). Thus, and in accordance with the principles of the invention, tap 400 is used to provide a server function in the cable system.

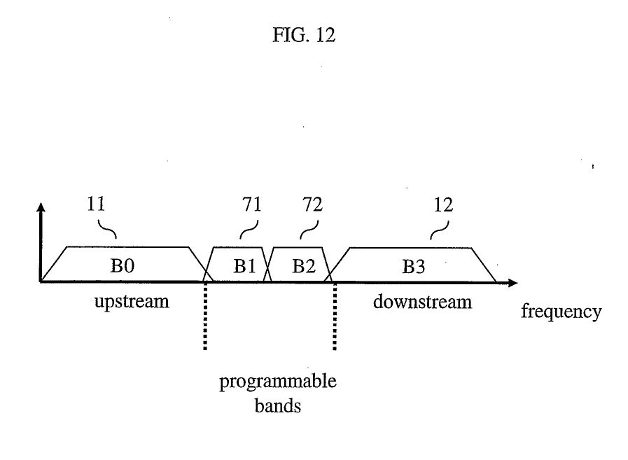

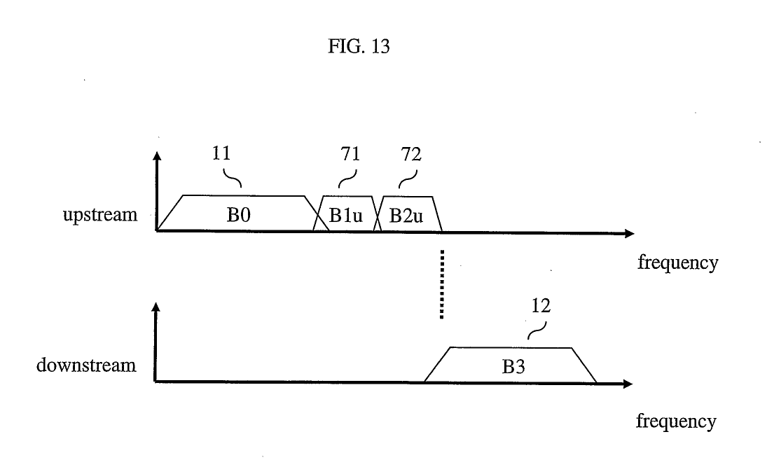

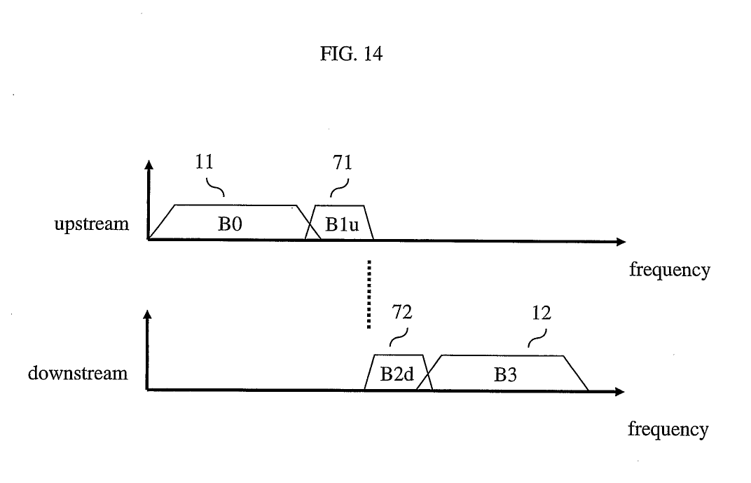

As described above, peer-to-peer channels may be used to convey the local services as illustrated in FIG. 2. These peer-to-peer channels are different from the existing upstream and downstream channels used to convey programming and Internet communications in the cable system. Alternatively, an existing channel used to convey downstream programming may also be used in accordance with the principles of the invention. This was illustrated in FIGS. 7 and 8 in the context of using a preexisting video channel. In addition, since it is difficult to reuse just any downstream channel, a band select amplifier may be used that allows a boundary between upstream and downstream communications to be moved over different portions of the cable network. In accordance with the principles of the invention, the bandwidth of cable system 100 is divided into a number of bands as illustrated in FIG. 12. There is a fixed upstream band B0 (11) for upstream communications, a fixed downstream band B3 (12) for downstream communications and a number of programmable bands, as represented by B1 (71) and B2 (72). Illustratively, the programmable bands are arranged between upstream band B0 and downstream band B3, but the inventive concept is not so limited as to either the location of these bands or their number. As a result, in a particular portion of the cable network the boundary between upstream and downstream communications can be moved. This is illustrated by FIGS. 13 and 14. In FIG. 13, the upstream communications initially include bands B1 and B2. In FIG. 14, it can be observed that one of the upstream bands, B2 (72) has now been allocated to downstream communications. In the context of these figures, the suffix “u” or “d” is attached to the band B1 or B2 as appropriate to further indicate whether B1 or B2 is allocated to the upstream or downstream directions, respectively.

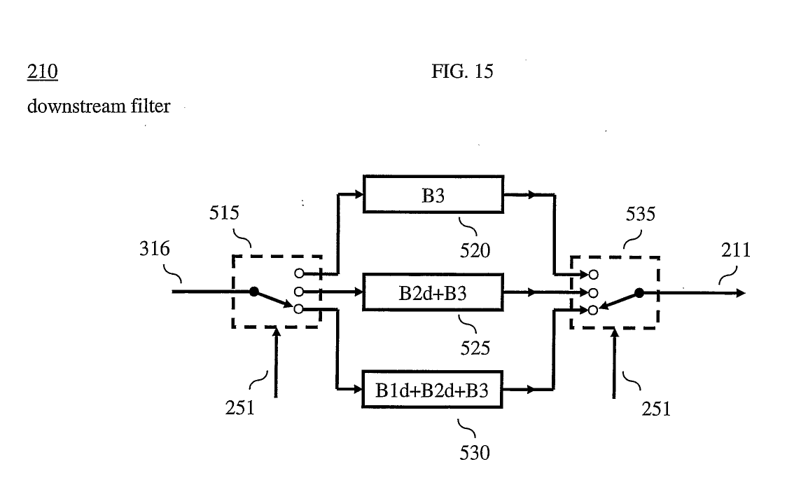

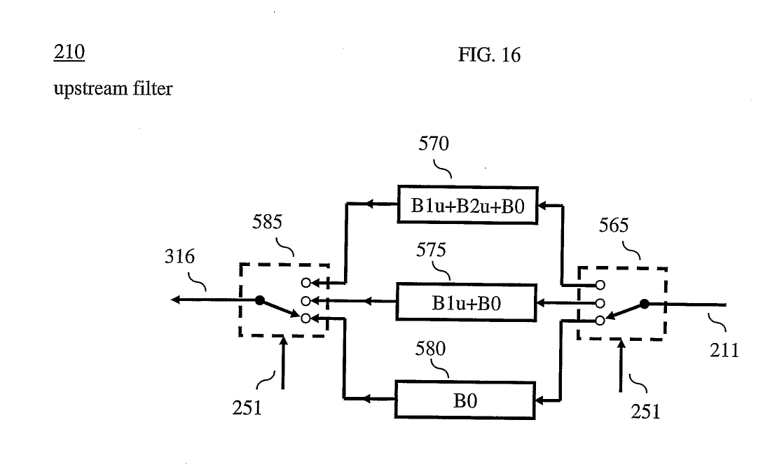

Turning now to FIGS. 15 and 16, an illustrative block diagram of filter 210 for use in the above-described server embodiments is shown. FIG. 15 illustrates the downstream filter portion of filter 210, this comprises a bank of filters 520, 525 and 530, along with multiplexers (switches) 515 and 535, which are controlled via the above-described control signal 251. As shown in FIG. 15, the multiplexers are used to route the signal through one of the filters as determined by control signal 251. Each filter has a pass band that corresponds to one of the downstream bands shown in FIG. 12 (again, the suffix d denotes the filter is in the downstream path). For example, if only filter 520 is selected then any downstream communications using bands B1 and B2 from the head-end are blocked, freeing those bands for use by server 300. In this regard, the out-of-band signaling channel is modified to include predefined commands that are associated with particular bandwidth configurations.

Similar comments apply to FIG. 16, which illustrate the upstream filter portion of filter 210. This portion comprises a bank of filters 570, 575 and 580, along with multiplexers (switches) 565 and 585, which are controlled via control signal 251. As shown in FIG. 16, the multiplexers are used to route the signal through one of the filters as determined by control signal 251. Each filter has a pass band that corresponds to one of the upstream bands shown in FIG. 12 (again, the suffix u denotes the filter is in the upstream path).

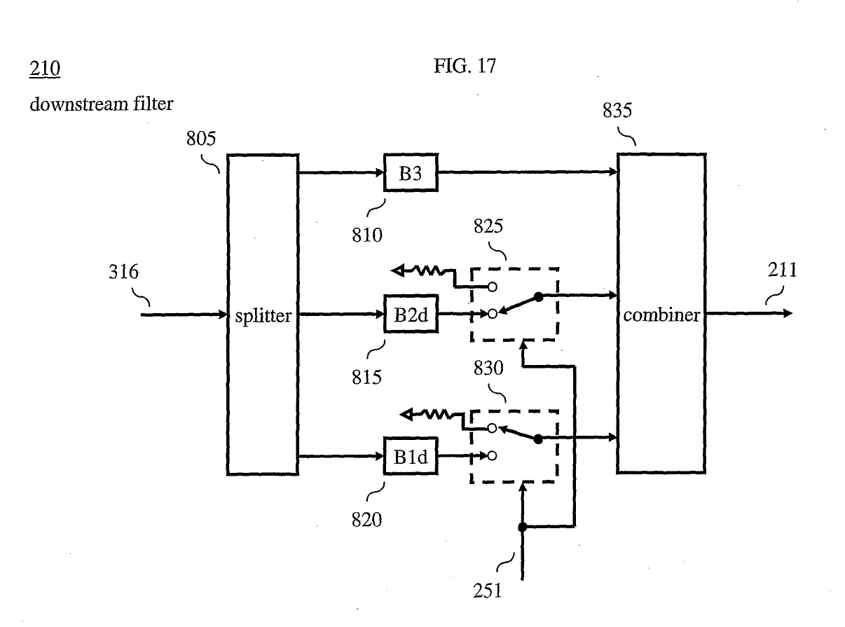

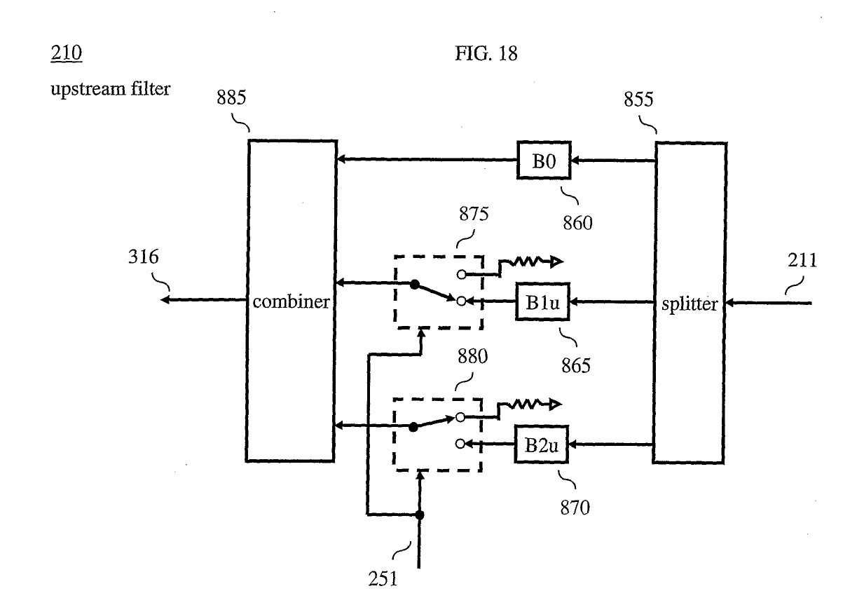

Other illustrative embodiments of a filter 210 in accordance with the principles of the invention are shown in FIGS. 17 and 18, which show alternative embodiments for the downstream and upstream portions of filter 210. In FIG. 17, the downstream filter portion comprises a splitter 805, a set of filters 810, 815 and 820, multiplexers (switches) 825 and 830 and a combiner 835. The downstream signal 316 is applied to splitter 805, which splits the signal for application to each filter. As shown in FIG. 17, filter 810 has a pass band B3; filter 815 has a pass band B2 (again, the suffix d denoting the filter is in the downstream path) and filter 820 has a pass band B1. Multiplexers 825 and 830 are controlled via control signal 251 to either pass or block signals from their respective filters for application to combiner 835. The latter combines any applied signals and forms the downstream signal 211.

Likewise, in FIG. 18, the upstream portion comprises a splitter 855, a set of filters 860, 865 and 870, multiplexers (switches) 875 and 880 and a combiner 885. The upstream signal 211 is applied to splitter 855, which splits the signal for application to each filter. As shown in FIG. 18, filter 860 has a pass band B0; filter 865 has a pass band B1 (again, the suffix u denoting the filter is in the upstream path) and filter 870 has a pass band B2. Multiplexers 875 and 880 are controlled via control signal 251 to either pass or block signals from their respective filters for application to combiner 885. The latter combines any applied signals and forms the upstream signal 311.

As described above, the inventive concept provides an alternative approach for providing local service offerings to customers in a cable network. Thus, it is possible to provide location-specific information to different portions of the cable network, such as video from a guard house of an apartment complex, or news and information of interest to a local group on a portion of the cable network.

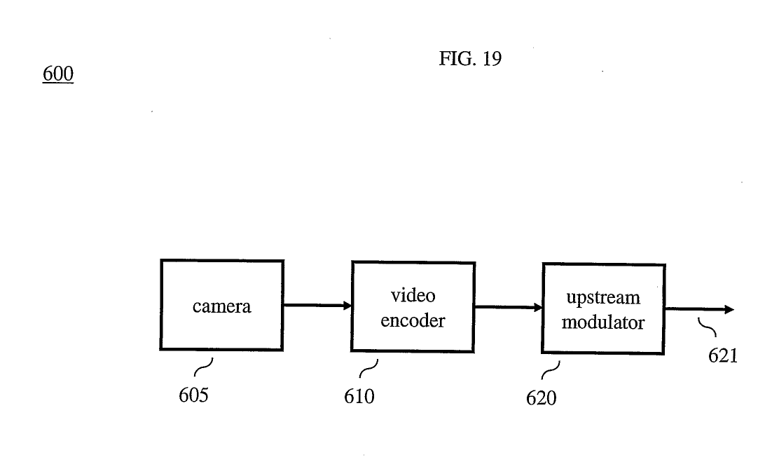

Turning now to FIG. 19, an illustrative embodiment of an apparatus for use in one, or more, of the stations of the cable system of, e.g., FIG. 1, is shown. Apparatus 600 comprises camera 605, video encoder 610 and upstream modulator 620. The physical location of the various components can vary, i.e., camera 605 does not have to be co-located with upstream modulator 620. Alternatively, two or more of the elements shown in FIG. 19 can be arranged in a single unit (e.g., a video camera that includes upstream modulator 620). Camera 605 provide a video signal to video encoder 610. The latter compress the video signal into a compressed video format (e.g., MPEG2, H.263, H.264, VC1, or other formats). The compressed video is provided to upstream modulator 620 for modulation in the appropriate upstream channel for communication to, e.g., server 200 (or server 300, etc.).

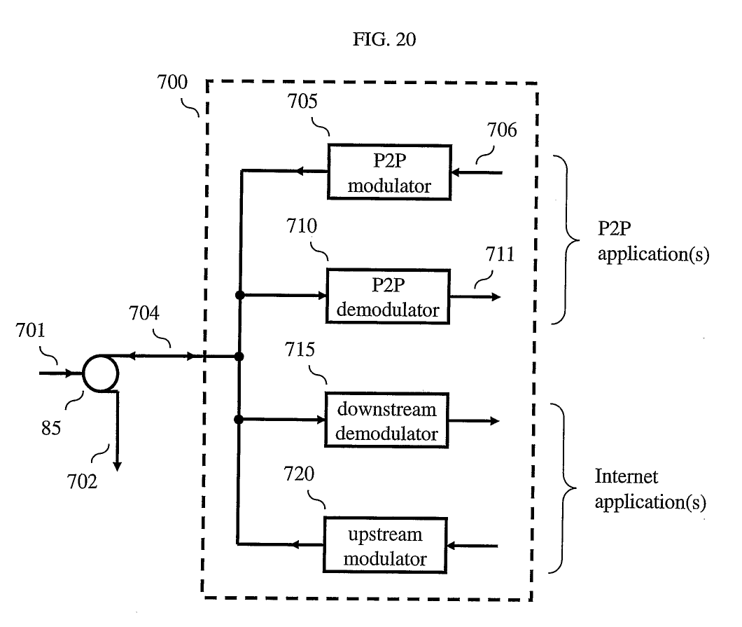

Another illustrative embodiment of a cable modem in accordance with the principles of the invention is shown in FIG. 20. Cable modem 700 comprises a peer-to-peer (P2P) modulator 705, a P2P demodulator 710, a downstream demodulator 715 and an upstream demodulator 720. Cable modem 700 is coupled to a cable network via a drop 701, a splitter 85 and path 704. The splitter 85 also provides a cable signal 702 to other equipment located at the station, e.g., a set top box (not shown). Upstream modulator 720 and downstream modulator 715 function as known in the art and enable a user to have Internet service and run Internet applications (e.g., a browser located on a personal computer (PC) (not shown). P2P modulator 705 and P2P demodulator 710 provide the above-mentioned peer-to-peer connectivity and are configurable to one, or more, of the peer-to-peer bands (e.g., as illustrated in FIG. 2). These settings may be determined via software as options set by the user via the PC coupled to cable modem 700. In addition, the PC may store address information for particular members of the peer-to-peer network, where each address is associated with a particular peer-to-peer band. Upstream peer-to-peer communications is provided via signal 706 to P2P modulator 705, which provides an upstream signal in the designated peer-to-peer band. Downstream peer-to-peer communications is provided via signal 711 from P2P demodulator 710, which demodulates received signal in the designated peer-to-peer band. As described herein, peer-to-peer communications includes not only messaging, but also, e.g., broadcast messages, multi-casting, etc. For example, a user can stream content from one endpoint to one or more other endpoints of the cable system in accordance with the principles of the invention. This content can be video, audio, etc. Further, although the inventive concept was described in the context of application to a traditional cable system, the inventive concept is not so limited and is applicable to any form of network, even, e.g., a home network, campus network, etc.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs). Similarly, although shown as separate elements, any or all of the elements may be implemented in a stored-program-controlled processor, e.g., a digital signal processor (DSP) or microprocessor that executes associated software. For example, the separate modulator and demodulator functions shown in FIG. 3 may be located in one, or more, DSPs. Further, although shown in particular configurations, the elements therein may be distributed in different units in any combination thereof. For example, a cable modem may be a part of a personal computer, etc. It is therefore to be understood that numerous modifications may be made to the illustrative embodiments and that other arrangements may be devised without departing from the spirit and scope of the present invention as defined by the appended claims.

1. Apparatus for use in a network, the apparatus comprising:
a port for receiving a downstream network transmission;
a demodulator for receiving an upstream signal for providing a demodulated signal; and
a modulator for modulating the demodulated signal for providing a downstream signal for addition to the received downstream network transmission.

2. The apparatus of claim 1, the apparatus further comprising:
a filter for filtering the received downstream network transmission prior to addition of the downstream signal, wherein the filter has a stop band that covers at least a frequency range of the downstream signal.

3. The apparatus of claim 2, wherein the stop band of the filter is adjustable.

4. The apparatus of claim 1,
wherein the demodulator includes a decoder for use in decoding coded content in the received upstream signal; and
wherein the modulator includes a coder for use in coding the decoded content.

5. The apparatus of claim 4, wherein the content is video;

6. The apparatus of claim 5, wherein the coder is an MPEG2 coder.

7. The apparatus of claim 1, further comprising:
a demodulator for demodulating a video transport portion of the received downstream network transmission for providing a video transport signal representing a number of video channels; and
a multiplexer for combining the video transport signal with the demodulated signal before modulation by the modulator.

8. The apparatus of claim 7, wherein the multiplexer replaces at least one of the video channels with the demodulated signal.

9. The apparatus of claim 1, wherein the apparatus is a part of a tap for use in the network.

10. The apparatus of claim 1, further comprising:
a network control interface responsive to a control signal for enabling or disabling the modulator.

11. The apparatus of claim 10, wherein the control signal is an out-of-band control signal.

12. The apparatus of claim 1, wherein the network is a cable network.

13. A method for use in a device of a system, the method comprising:
receiving a downstream network transmission;
receiving an upstream signal for providing a demodulated signal; and
modulating the demodulated signal for providing a downstream signal for addition to the received downstream network transmission.

14. The method of claim 13, further comprising:
filtering the received downstream network transmission prior to addition of the downstream signal, wherein the filter has a stop band that covers at least a frequency range of the downstream signal.

15. The method of claim 14, wherein the stop band of the filter is adjustable.

16. The method of claim 13,
wherein the demodulating step includes
decoding coded content in the received upstream signal; and
the modulating step includes:
coding the decoded content.

17. The method of claim 16, wherein the content is video;

18. The method of claim 17, wherein the coding step performs MPEG2 coding.

19. The method of claim 13, further comprising:
demodulating a video transport portion of the received downstream network transmission for providing a video transport signal representing a number of video channels; and
combining the video transport signal with the demodulated signal before modulation by the modulator.

20. The method of claim 19, wherein the combining step replaces at least one of the video channels with the demodulated signal.

21. The method of claim 13, wherein the device is a part of a tap for use in the network.

22. The method of claim 13, further comprising:
receiving a control signal for enabling or disabling the device.

23. The method of claim 22, wherein the control signal is an out-of-band control signal.

24. The method of claim 13, wherein the network is a cable network.
